(19) United States
(12) Patent Application Publication
(10) Pub. No.: US 2014/0366623 A1
(43) Pub. Date: Dec. 18, 2014

(54) Self-Illuminating Windsock

(71) Applicant: EnerSafe, Inc., Houston, TX (US)

(72) Inventor: Jason R. Anderson, Flint, TX (US)

(21) Appl. No.: 14/304,251

(22) Filed: Jun. 13, 2014

Related U.S. Application Data
(60) Provisional application No. 61/835,135, filed on Jun. 14, 2013.

(51) Int. Cl. G01W 1/02; G01P 5/02; G01P 13/00

(52) U.S. Cl. CPC G01W 1/02; G01P 13/0013; G01P 5/02
USPC 73/170.06; 29/428

(57) ABSTRACT

An illuminated windsock, including a windsock assembly coupled to a windsock. The windsock assembly may comprise a base in which a windsock ring is attached. The windsock ring is coupled to the windsock, attaching the windsock to the windsock assembly. A housing provides for the rotation of the ring and base around a vertical axis. The windsock assembly may further include a mount to secure the windsock assembly to a structure and a light shade to house an illumination device. Solar panels or cells may be present to provide energy for the illumination device.

### CROSS-REFERENCE TO RELATED APPLICATION

This application is a non-provisional of U.S. Provisional Application No. 61/835,135 filed on Jun. 14, 2013, which is incorporated herein by reference in its entirety.

### BACKGROUND

The present invention relates generally to windsocks and, more specifically, to portable self-powered windsock apparatus and installation for remote application such as at an outlying oil and gas facility.

A windsock is generally a conical textile tube that indicates wind direction and speed. The windsock typically is a tube of lightweight fabric, and is mounted on a pole. The windsock may swivel freely around the pole so that it can move as the wind changes direction. A light breeze will partly lift the windsock (tube) horizontally and partially fill it with air, causing it to project horizontally from the pole while the end of the tube hangs down generally vertically. As the wind picks up, the end part of the tube that droops down vertically will gradually extend horizontally. In high winds, the entire windsock will be fully extended horizontally at a 90-degree angle from the pole. Thus, wind speed may be indicated by the windsock's angle relative to the vertical mounting pole. In low winds, the windsock droops. Again, in high winds, the windsock flies substantially horizontally at an approximate right angle to the vertical mounting pole.

Wind direction is typically the opposite of the direction in which the windsock is pointing. In other words, wind directions are conventionally specified as being the compass point from which the wind originates. Thus, a windsock pointing due north indicates a southerly wind, for instance. Also known as a wind cone, a windsock is commonly bright in color to be more visible. A lighted windsock can be used at night in airports where pilots make night landings, for instance. The included light may internally light the windsock or instead be an obstructionist light above the windsock.

Windsocks are used in many industries such as airports, chemical plants (where there is risk of gaseous leakage), and for personal use (for practical and ornamental use). Windsocks are installed at airports to provide pilots with information about wind on the ground that affects landing. In addition, windsocks may be placed along high wind areas of a road or freeway to warn drivers when winds are high. Further, windsocks may be used at facilities like chemical plants and refineries where wind direction and speed may be important to know for evacuation of personnel in the event of a chemical release. Several windsocks may be scattered around a facility.

In the case of a hazardous gas or vapor leak at a facility, the windsock by indicating wind direction and speed may provide an idea of the dispersion and travel direction of the leaked gas or vapor, whether the leaked gas or vapor forms a cloud or is more dispersible. In the event of such a leak, the facility personnel may be instructed to walk cross-wind, i.e., perpendicular to the direction of the windsock, to evacuate the area to a rally point or off-site.

### BRIEF DESCRIPTION OF THE DRAWINGS

These drawings illustrate certain aspects of the present invention and should not be used to limit or define the invention.

FIG. 1 is a perspective view of a windsock assembly in accordance with embodiments of the present techniques;

FIG. 2 is a block flow diagram of a method of installing a windsock assembly at an outlying oil and gas facility in accordance with embodiments of the present techniques;

FIG. 3 is a perspective view of a windsock assembly in accordance with embodiments of the present techniques with an LED light rope around a windsock ring;

FIG. 4 is a perspective view of an installed windsock assembly; and

FIG. 5 is a top perspective of an installed windsock assembly and its placement in an outlying oil and gas facility.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill in the art and having the benefit of this disclosure.

Embodiments of the present techniques are directed to a windsock assembly configured to be installed in outlying oil and gas facilities with limited or no on-site electricity supply. Embodiments include a directional windsock assembly with a light or beacon that is a solar-powered, and thus not requiring conventional power supply wiring. Therefore, the windsock assembly may be labeled as wireless. In certain embodiments, the windsock assembly is a self-sufficient solar charging system and includes some form of environment light sensor. During well-lit daytime hours, the light or beacon powers off and its power supply (e.g., battery) charges. Conversely, in low-light or poor visibility, the light or beacon may automatically turn on. In other embodiment, the self-sufficient solar charging system may turn the beacon power off and on through a timer, not pictured. The timer may be set for pre-determined times in which it may turn the beacon on and off. The times may be reset in accord with the conditions and environment in which the windsock assembly 10 may be placed. In still further embodiments, after the windsock assembly is installed, the light or beacon may be activated by merely depressing a button or flipping a switch, for example. In this instance, activation may mean that the cycle of the light powering on and off is initiated.

Windsocks may be used in the oil and gas industry at production, processing, storage and transportation facilities. Windsocks may be beneficial at locations and facilities involving drilling, well workover and intervention, production facilities, well completions, drilling fluids, well testing, and so on. Windsocks may be installed on tank batteries, gang trucks, drilling rigs, pulling units, water stations, satellite stations and entrances to fields or locations, and so forth. Windsocks indicate wind direction and speed which may be useful information in the case of a chemical leak or unintended release, such as with hydrogen sulfide (H2S) and other hazardous chemicals. It is generally beneficial for workers at such sites to be aware of wind direction, especially when opening a closed system, for example, such as when opening piping, vessels, or equipment, or to gauge a tank, check a mud pit, open a pig launcher, or check an orifice, and so on. Indeed, oil and gas workers may routinely perform maintenance duties and daily activities in the presence of hazardous chemicals. The windsocks may be used by the workers or other personnel to determine wind direction, which may be helpful to aid in the determination of a safe zone as understood by the skilled artisan.

A windsock can be a line of defense when personnel are in the presence of toxic gases. Toxic gases, such as hydrogen sulfide gas, exist in the oil and gas industry. Indeed, a primary airborne hazard present in the oil and gas industry is hydrogen sulfide, which is colorless and heavier than air. In high concentrations, hydrogen sulfide has little or no smell. Although very pungent at first, hydrogen sulfide quickly deadens the sense of smell, so potential victims may be unaware of its presence. Hydrogen sulfide at low concentrations has the odor of rotten eggs, but at higher, lethal concentrations, is odorless.

Hydrogen sulfide is hazardous to workers and a few seconds of exposure at relatively low concentrations can be lethal, but exposure to lower concentrations can also be harmful. Hydrogen sulfide concentrations as low as 300-600 part per million (ppm) can be lethal. In even lower concentrations, hydrogen sulfide can cause eye irritation, sore throat and cough, nausea, shortness of breath, and fluid in the lungs. Hydrogen sulfide is also a flammable gas. Moreover, being heavier than air, hydrogen sulfide tends to accumulate at the bottom of poorly ventilated spaces.

Awareness, detection, and monitoring of hydrogen sulfide are advantageous. Since hydrogen sulfide gas is present in some subsurface formations, drilling and other operational crews should be prepared to use detection equipment, personal protective equipment, proper training and contingency procedures in H2S-prone areas. Hydrogen sulfide is produced during the decomposition of organic matter and occurs with hydrocarbons in some areas. It enters drilling mud from subsurface formations and can also be generated by sulfate-reducing bacteria in stored muds.

A problem with many oil and gas facilities is that while hydrogen sulfide may be readily present, such locations are remote, not well lit, and/or do not have readily available electricity supply. To accommodate these limitations, the present techniques provide for a portable windsock assembly that may be installed and operated in remote or outlying oil and gas facility locations. As indicated, the windsock assembly may be solar-powered with a chargeable battery. In addition, the windsock assembly may have an additional back-up battery for use in extended periods of dim environment light conditions.

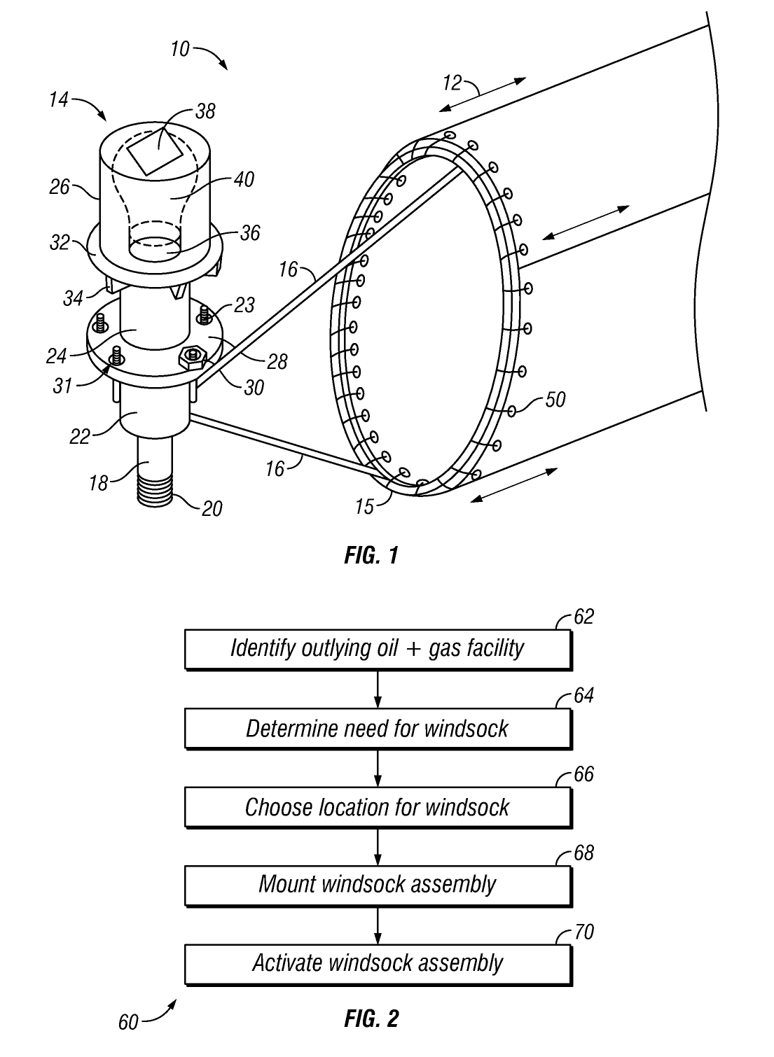

FIG. 1 is an example of a windsock assembly 10 which may be installed at facilities in remote, out-of-the-way, or outlying oil and gas facility areas, and where being aware of wind speed may be beneficial, such as at various oil and gas production, storage, and transportation facilities handling hazardous chemicals. Windsock assembly 10 may comprise a windsock (as represented by arrows 12) and a base 14. Windsock 12 may couple to a loop or ring 15 of base 14. In the illustrated embodiment, ring 15 may be supported by two legs 16. In some embodiments, ring 15 may be supported by a single leg 16 or a plurality of legs 16. Legs 16 may attach to ring 15 by any suitable means. Suitable means may include, but are not limited to welding, nuts and bolts, clips, casting, or any combination thereof. Legs 16 may be positioned in any manner to support ring 15 and windsock 12. Legs 16 may be a pipe, conduit, or bar stock, for example, and may be constructed of metal, high-strength polymer, reinforced plastic, and so forth. Further, legs 16 may be attached to a housing 22, which may allow for legs 16 and windsock 12 to rotate. Legs 16 may be attached to housing 22 by any suitable means, suitable means may include, but are not limited to welding, nuts and bolts, clips, casting, or any combination thereof. In one example, as illustrated in FIG. 1, windsock 12 may include holes 50 through which windsock 12 may be secured to ring 15. For example, a wire, a cable tie, a rope, or some other type of fastener may be used to couple windsock 12 and ring 15 via holes 50. Ring 15 may be sized according to standard size(s) of windsocks and include typical or standardized windsock coupling features.

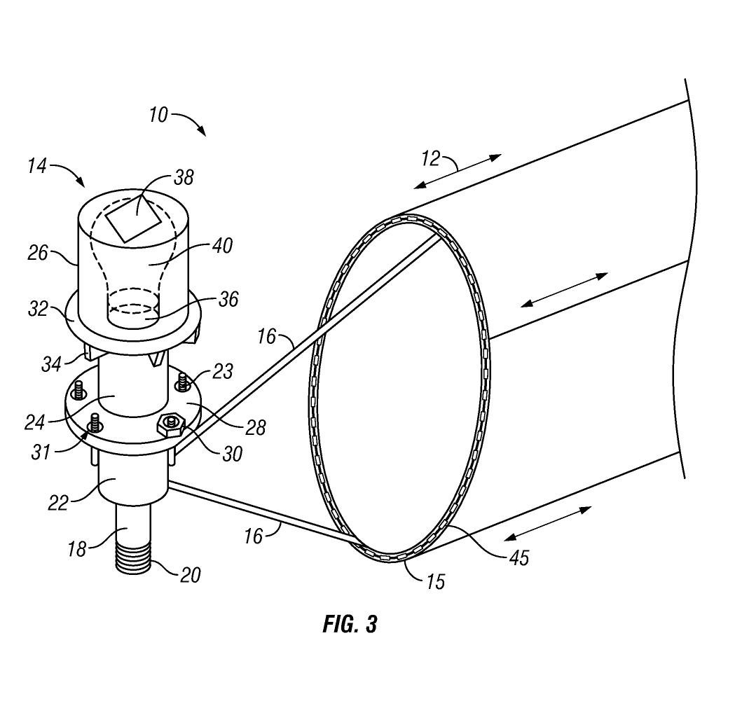

While not shown, windsock 12 may be illuminated in accordance with example embodiments. For example, a light source 40 may be disposed on ring 15 to illuminate windsock 12. Light source 40 may be differing types of bulbs or sources, including incandescent, a light-emitting diode (LED), fluorescent, high-intensity discharge (HID), strobe, and so forth. In some embodiments, as illustrated in FIG. 3, light source 40 may be in the form of LED rope lighting 45. Illustrated in FIG. 3, a LED rope light 45 may traverse ring 15. This may illuminate ring 15, and in turn illuminate windsock 12. LED rope lights 45 may further be attached to windsock 12. LED rope lights 45 may traverse the length of windsock 12 and further may be located on the outside or inside of windsock 12. There may be any number of LED rope lights 45 suitable to illuminate windsock 12.

Windsock assembly 10 may mount at the outlying facility via mount leg 18 having threads 20 and/or other coupling features. Mount leg 18 may be a pipe, conduit, or bar stock, for example, and may be constructed of metal, high-strength polymer, reinforced plastic, and so forth. Mount leg 18 may be depicted as cylindrical but may be other geometries. External electrical supply wires are not required to be routed through mount leg 18 or elsewhere to the windsock assembly 10, in embodiments where windsock assembly 10 may be self-powered (e.g., solar powered with battery back-up).

Mount leg 18 may be attached to a bearing, no shown. Housing 22 may rest on the bearing. Housing 22 encloses or partially encloses the bearing. Housing 22, resting on the bearing, and mount leg 18 attached to the bearing may allow for a swivel motion of windsock assembly 10 with respect to mount leg 18, this may allow windsock 12 to rotate with wind direction. Further, in this example, a neck 24 is disposed between housing 22 and light shade 26. Neck 24 may be of any length or diameter in order to properly support light shade 26, a light source 40, and self-sufficient solar charging system. Neck 24 may be hollow or solid. In embodiments, neck 24 may be hollow, which may allow for wires, electronics, and parts of a self-sufficient solar charging system to pass from light shade 26 to housing 22. In certain embodiments, housing 22 may couple to neck 24 via mating flanges 28, a plurality of studs 23, and a plurality of nuts 30. Flange 28 may be attached to neck 24 by any suitable means, which may include, but is not limited to a weld, casting, nuts and bolts, or any combination thereof. Flange 28 may have cutouts 31, in which studs 23 may pass through. Cutouts 31 may be of any shape suitable to allow for studs 23 to pass through. Suitable shapes may be, but are not limited to, circular, rectangular, polyhedral, or any combination thereof. Studs 23 may be threaded at the end opposite housing 22. There may be a plurality of cutouts 31 and a plurality of studs 23, which may properly secure flange 28 to housing 22. Studs 23 may be welded, casted, or pressed into housing 22. Studs 23 may be of any suitable length to properly secure flange 28. A suitable length may be about one inch, about two inches, about three inches, about four inches, about five inches, or about six inches. Nuts 30 may rotate around the threads on studs 23, securing flange 28 to housing 22. Nut 30 may be any suitable configuration of nut 30 in order to properly secure flange 28. A suitable configuration of nut 30 may be a cap nut, castle nut, lock nut, or any combination thereof. Furthermore, the inner diameter of nut 30 and outer diameter of stud 23 may be of any suitable length in order to properly secure flange 28 and not shear from applied forces. A suitable inner diameter for nut 30 and outer diameter of stud 23 may be a length in the range from about ten centimeters to about a quarter of an inch. Of course, other coupling features may be employed, such as threads or fastening elements, for instance.

Light shade 26 may rest atop a shade base surface 32 having optional underlying supports 34. In embodiment, light shade 26 may be enclosed by, but is not limited to a guard, light weight fencing, or covering in which to protect light shade 26 from external elements or when light shade 26 may encounter hardened objects. All enclosures of light shade 26 may not hinder the illumination from light source 40 enclosed in light shade 26. Furthermore, the enclosures may not hinder the amount of light absorbed by the self-sufficient solar charging system, enclosed by light shade 26. Light shade 26 may be translucent or any color and enclose a light source 40. Light source 40 may be differing types of bulbs or sources, including incandescent, a light-emitting diode (LED), fluorescent, high-intensity discharge (HID), strobe, and so forth. A mating component 36 for the light such as a socket, receptacle, plate, or other mating feature, is disposed within shade 26. Neck 24 may include electronics associated with power supply to the light of the windsock assembly 10, for instance.

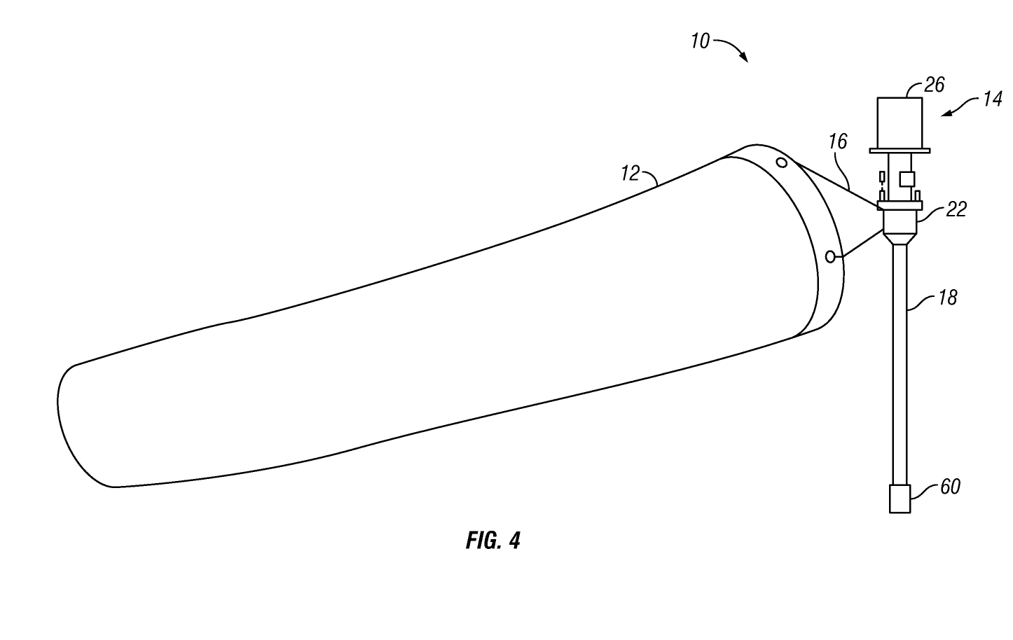

As illustrated in FIG. 4, light shade 26 is depicted at a higher elevation than windsock 12, which may provide for light source 40 to illuminate the external surface of windsock 12. However, in alternate embodiments, light shade 26 may be positioned such that light source 40 may illuminate more of the internal surface of windsock 12. Further illustrated in FIG. 4, windsock assembly 10 is depicted in an installed state. Mount leg 18 is illustrated extending down from windsock assembly 10 to a structure 60. Mount leg 18 may be any suitable height, which may allow for windsock 12 to function in an area free of wind obstructions. A suitable height for mount leg 18 may be about one foot, about five feet, about ten feet, about fifteen feet, about twenty feet, about twenty-five feet, or about thirty feet. Mount leg 18 may be threaded on both end and may attached to windsock 10 and structure 60 with opposing threads. Mount leg 18 may attach to windsock 12 and structure 60 by any suitable means. Suitable means may be, but is not limited to, a weld, nuts and bolts, snap ring, screws, snap connection, or any combination thereof.

As illustrated in FIG. 1 and FIG. 3, shade base surface 32 may support light shade 26 and any enclosure means. Shade base surface 32 and underlying support 34 may be made of any material, which may include, but is not limited to metal, high-strength polymer, reinforced plastic, or any combination thereof. Both shade base surface 32 and underlying support 34 may be casted together or attached by any suitable means. Suitable means of attachment may include, but is not limited to nuts and bolts, screws, weld, or any combination thereof. Further, shade base surface 32 may be attached to neck 24 by any suitable means. Suitable means may include, but is not limited to nuts and bolts, screws, weld, casting, or any combination thereof.

As mentioned, windsock assembly 10 may rely on solar energy to power the light and any other electronics in windsock assembly 10. As appreciated by the skilled artisan, solar power is the conversion of sunlight into electricity, and obtained typically by utilizing photovoltaics in smaller applications. In certain examples, photovoltaics generate electrical power by converting solar radiation into direct current electricity using semiconductors that exhibit the photovoltaic effect. Photovoltaic power generation commonly employs solar panels composed of a number of solar cells containing a photovoltaic material. Materials used for photovoltaics can include monocrystalline silicon, polycrystalline silicon, amorphous silicon, cadmium telluride, and copper indium gallium selenide/sulfide, and the like. Due to the growing demand for renewable energy sources, the manufacturing of solar cells and photovoltaic arrays has advanced considerably in recent years.

To be consistent with the portable and self-contained nature of embodiments of windsock assembly 10, windsock assembly 10 may include a solar receiver 38 installed on base 14, such as a solar panel or cell and may employ various photoelectronics. Thus, windsock assembly 10 may not be required to rely on solar features separate from base 14. In the illustrated embodiment of FIG. 1, solar receiver 38 may be disposed on top of light shade 26, but may be installed elsewhere in windsock assembly 10. One or more batteries may be electrically coupled to solar receiver 38. In one embodiment, the batteries may be located in light shade 26 beneath solar receiver 38. Solar receiver 38 may be disposed in one or more locations on windsock assembly 10 that may be more directly exposed to sunlight when windsock assembly 10 is installed. The solar energy captured by solar receiver 38 may be conveyed to and processed by components within neck 24, within light shade 26, housing 22, solar receiver 38, or any combination thereof.

FIG. 2 may be a method 60 for installing windsock assembly 10 at an outlying facility in the oil and gas industry. Initially, an existing or to-be-constructed outlying oil and gas facility may be identified (block 62). Such a facility may have no or limited electrical supply infrastructure. A need for windsock assembly 10 at the facility may be determined (block 64). The need may be determined based on an absence of existing windsock assemblies 10 and the presence or potential presence of a hazardous material, such as hydrogen sulfide or other toxic, flammable, or explosive materials. If at the outlying facility, such hazardous materials are susceptible to leakage or release to the environment as a gas or vapor, then one or more windsocks may be needed.

After determining that a windsock assembly 10 may be applicable at the outlying facility, a position or location for one or more windsocks at the outlying facility may be chosen (block 66). In general, the positions may be specified such that windsocks will be readily visible and dispersed as needed. Such positioning or locating may be per regulatory, industry, or company standards. Further consideration in placing windsock assembly 10 take into account the ability for windsock assembly 10 to have an unobstructed wind channel in every direction. Windsock assembly 10 should be placed at a minimum about ten feet above the ground and at a maximum of no more than thirty feet above the highest point in any working area.

After a location or position is selected, then windsock assembly 10 having a base 13 and a windsock 12 may be placed or mounted (block 68) in the selected location. As indicated above, base 14 of windsock 12 may have a rotatable feature such that an attached windsock 12 may rotate with the wind direction. Base 14 of windsock assembly 12 may be mounted to existing structure at the facility, such as piping, conduit, pipe rack, platform, bracing, and so forth. In lieu of existing structure, a support structure (e.g., a pole) may be installed to mount base 14 of windsock assembly 10. The mounting of base 14 of windsock assembly 10 to a structure may involve a threaded connection, claps, bolting, welding, or other coupling features. As for the fabric windsock, it may be installed on a support ring 15 of base 14 of windsock assembly 10. Support ring 15 may be sized to receive a standard size windsock 12 or other sizes.

Lastly, after mounting of base 14 of windsock assembly 10 and attachment of windsock 12 to base 14, operation of windsock assembly 10 may be activated (block 70). In some examples, windsock assembly 10 may be activated by simply pushing a button or a switch, for instance, such that the solar panel or cell may be operational, store energy, and supply power to light source 40 or beacon of windsock assembly 10. Moreover, in certain embodiments, independent electrical wiring or electrical supply may not be required, as windsock assembly 10 may be self-powered, such as with a solar cell and battery back-up. Thus, the relatively portable windsock assembly 10 may be mounted and then quickly activated (made operational) by a push of a button, for instance. Thus, the assembly may be succinctly ready for service without requiring an electrical supply or wiring, or requiring a specialized support structure in some facility applications.

Reading a windsock 12 may be relatively easy. As discussed above, the wind originates from the opposite direction the windsock points. For example, if a windsock 12 is pointing east, the wind is a west wind, i.e., the wind originates from the west. If windsock 12 is partially extended, the air speed may be relatively low. The more extended the cone, the higher the wind speed. Windsocks may be marked with rings so that people can more clearly see how much of the cone may be extended at any given time. Wind cones manufactured to Federal Aviation Administration (FAA) standards fully extend in winds exceeding 17 miles per hour (28 kilometers per hour or 15 knots). An anemometer, for example, may be employed to measure wind speed to take measurements when windsocks are at various stages of extension in order to learn which speed each stage corresponds.

Windsocks of the present techniques may be designed and constructed to meet the related Federal Aviation Administration (FAA) specification for windsock assemblies, such as FAA Advisory Circular No. 150/5345-27D, which requires that a 15-knot (28 km/h; 17 mph) wind fully extend the properly functioning windsock, and a 3-knot (5.6 km/h; 3.5 mph) breeze causes the properly functioning windsock to orient itself according to the wind. Further, FAA design requirements for windsocks may include meeting any ambient temperature between −67° F. (−55° C.) and 131° F. (+55° C.), and wind speeds up to 75 knots (140 km/hr or 86 mph). Of course, the present windsocks may not meet any certain standard, or may meet other standards.

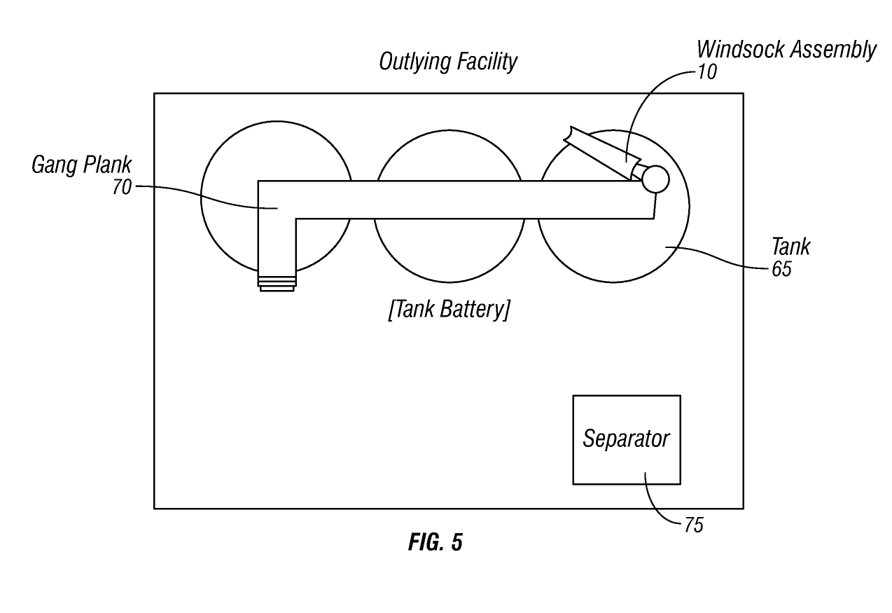

FIG. 5 illustrates an exemplary outlying oil and gas facilities that may be candidates for embodiments of windsock assembly 10 of the present techniques. Of course, the facilities depicted in are not meant to limit the application of windsock assembly 10. Indeed, windsock assembly 10 of the present techniques may be applicable to a variety of Other outlying oil and gas facilities. As outlying oil and gas facility, as illustrated in FIG. 5, depicts tanks 65, gang plank 70, separator 75, and a windsock assembly 10. A facility such as the one illustrated in FIG. 5 may not have consistent power. Winsock assembly 10 may be placed in the outlying facility in order to provide safety and warning for those who may come to the outlying facility during normal working conditions. Windsock assembly 10 may be installed upon gang plank 70, gang plank 70 may run along the top of tanks 65. Placement of windsock assembly 10 may allow windsock assembly 10 unobstructed access to any wind patterns in the general area. This may allow for windsock assembly 10 to better illustrate to workers in the facility the direction of the wind overhead.

Although the present invention and its advantages have been described in detail, it should be understood that various changes, substitutions and alterations may be made herein without departing from the spirit and scope of the invention as defined by the appended claims. Although individual embodiments are discussed, the invention covers all combinations of all those embodiments. While apparatus and methods are described in terms of “comprising,” “containing,” “having,” or “including” various components or steps, the apparatus and methods can also “consist essentially of” or “consist of” the various components and steps.

What is claimed is:

1. A system for placement of a windsock assembly at an outlying oil and gas facility comprising:
a windsock assembly base comprising:
a ring to receive a windsock;
a housing providing for rotation of the ring around a vertical axis of the windsock assembly;
a mount to secure the windsock assembly base to a conduit or structure;
a light shade to contain a light; and
a solar panel or cell that supplies power to the light.

2. The windsock assembly of claim 1, further comprising the windsock coupled to the ring to form the windsock assembly comprising the windsock assembly base and the windsock.

3. The windsock assembly of claim 1, wherein the windsock is connected to the ring with a cable tie.

4. The windsock assembly of claim 1, wherein the ring is supported by a plurality of legs.

5. The windsock assembly of claim 4, wherein the legs connect the ring to the housing.

6. The windsock assembly of claim 1, comprising a rechargeable battery coupled to the solar panel or cell and the light.

7. The windsock assembly of claim 1, wherein the light shade is translucent.

8. The windsock assembly of claim 1, wherein the light is a LED.

9. The windsock assembly of claim 8, wherein the light is positioned above the windsock to illuminate the windsock.

10. The windsock assembly of claim 8, wherein the light is positioned in line with the windsock to illuminate the inside of the windsock.

11. The windsock assembly of claim 1, wherein the light is a LED rope light.

12. The windsock assembly of claim 11, wherein the light is disposed on the ring.

13. The windsock assembly of claim 1, wherein the solar panel or cell is located on top of the light shade.

14. The windsock assembly of claim 1, wherein the solar panel or cell is located along the windsock.

15. A method for installing a windsock comprising:
locating an outlying facility;
determining the presence of hazardous materials;
assembling the windsock at the desired location, wherein the windsock assembly comprising:
a ring to receive a windsock;
a housing providing for rotation of the ring around a vertical axis of the windsock assembly base;
a mount to secure the windsock assembly base to a conduit or structure;
a light shade to contain a light; and
a solar panel or cell that supplies power to the light.

16. The method of claim 15, wherein the windsock assembly is mounted to an existing structure.

17. The method of claim 15, wherein the windsock assembly is activated after installation.

18. The method of claim 17, wherein the activation of the windsock assembly occurs by depressing a button or flipping a switch.

19. The method of claim 17, wherein the windsock assembly is activated and deactivated based on the amount of available light.

20. The method of claim 15, wherein the placement of a windsock assembly or placement of a plurality of windsock assembly's is based on government regulations.
